(19) United States
(12) Patent Application Publication
(10) Pub. No.: US 2021/0269307 A1
(43) Pub. Date: Sep. 2, 2021

(54) CARBON RECYCLING IN STEAM REFORMING PROCESS

(71) Applicant: HALDOR TOPSØE A/S, Kgs. Lyngby (DK)

(72) Inventors: Peter Mølgaard MORTENSEN, Roskilde (DK); Arunabh SAHAI, Faridabad, Haryana (IN)

(73) Assignee: HALDOR TOPSØE A/S, Kgs. Lyngby (DK)

(21) Appl. No.: 17/274,654

(22) PCT Filed: Sep. 26, 2019
(86) PCT No.: PCT/EP2019/076093

§ 371 Date: Mar. 9, 2021

(30) Foreign Application Priority Data
Oct. 15, 2018 (IN) 201811039071
Nov. 26, 2018 (DK) PA 2018 00909
Apr. 9, 2019 (DK) PA 2019 00442

(51) Int. Cl. C01B 3/50; C01B 3/52; C01B 3/56

(52) U.S. Cl. CPC C01B 3/506; C01B 3/52; C01B 3/56; C01B 2203/0233; C01B 2203/043; C01B 2203/0827; C01B 2203/0475; C01B 2203/048; C01B 2203/0872; C01B 2203/147; C01B 2203/148; C01B 2203/046

(57) ABSTRACT

A method for increasing the carbon utilisation of a synthesis gas plant is provided, as well as a synthesis gas plant arranged to perform said method. Various gas streams can be combined and recycled to allow for efficient use of a natural gas feedstock.

### TECHNICAL FIELD

The present invention relates to the field of steam reforming of a natural gas feedstock. In particular, a method for increasing the carbon utilisation of a synthesis gas plant is provided, as well as a synthesis gas plant arranged to perform said method. Various gas streams can be combined and recycled to allow for efficient use of a natural gas feedstock.

### BACKGROUND

In a typical synthesis gas (synthesis gas here denotes a mixture of comprising hydrogen and carbon monoxide) plant, a synthesis gas is purified to H₂ and CO by a combination of CO₂ removal and a cold box, and sometimes also a PSA. The synthesis gas is typically produced by steam reforming of natural gas.

Catalytic synthesis gas production by steam reforming a feed gas comprising hydrocarbons has been known for decades. The endothermic steam reforming reaction is typically carried out in a steam reformer (SMR) also denoted a steam methane reformer. A steam reformer has a number of catalyst filled tubes placed in a furnace. The tubes are normally 10-14 meters in length and 7-15 cm in inner diameter. Preferably, the steam reforming takes place at pressures in the range from 15-30 barg to allow for production of a pressured synthesis gas product directly from the reformer. The heat for the endothermic reaction is supplied by combustion of fuels in burners in the furnace. The synthesis gas exit temperature from the steam reformer depends on the application of the synthesis gas but will normally be in the range from 650° C.-980° C.

It is also known that, from a thermodynamic viewpoint, it is advantageous to have a high concentration of CO₂ and a low concentration of steam in the feed stream to promote the production of synthesis gas with a low H₂/CO-ratio. However, operation at such conditions may not be feasible due to the possibility of carbon formation on the catalyst.

An alternative method for production of a synthesis gas with a low H₂/CO ratio by steam reforming is a sulfur passivated reforming (SPARG) process which may be used for producing synthesis gas with a relatively low H₂/CO ratio. This process requires desulfurization of the produced synthesis gas to produce a sulfur free synthesis gas.

More details of various processes for producing synthesis gas with low H₂/CO ratio can be found in “Industrial scale experience on steam reforming of CO₂-rich gas”, P. M. Mortensen & I. Dybkjaer, Applied Catalysis A: General, 495 (2015), 141-151.

Known methods include those of US2010074811, U.S. Pat. No. 4,732,596 and EP0411506. Compared to EP0411506, the current technology has the general advantage that the CO₂ stream from the CO₂ removal and the off-gas from the cold box are at similar pressures (within 2-3 bar). In contrast, the configuration of EP0411506 will require individual expansion of one stream, or the separate compression of the other stream before they can be mixed overall this gives an inefficient process in EP0411506.

Efforts have been made to optimise the production and purification of synthesis gas. The purification process itself provides a number of separate gas streams with various compositions at various temperatures and pressures, and it would be beneficial to utilise these most effectively so that waste and/or burn-off can be avoided. Utilisation should be carried out in the most cost- and energy-efficient manner.

These issues are addressed by the present technology. Further advantages of the technology will become apparent from the following description, examples and patent claims.

### SUMMARY

It has been found that efficient recycling of the appropriate gas streams can be used to control CO production in a synthesis gas plant. Additional benefits of the present technology are apparent from the following detailed description and embodiments.

In a first aspect, a method is provided for increasing the carbon utilisation of a synthesis gas plant, said synthesis gas plant comprising a reforming section in which process gas is first reformed in at least one reforming step to a reformed gas stream; and a cooling section in which the reformed gas is cooled to provide a dry reformed stream comprising CH₄, CO, CO₂ and H₂, said method comprising the steps of:
a. passing the reformed stream to a CO₂ removal unit to separate it into at least:
   a purified CO₂ stream and
   a CO₂-scrubbed stream having a lower CO₂ content than said purified CO₂ stream;
b. passing the CO₂-scrubbed stream from the CO₂ removal unit to a cold box to separate it into at least:
   a cold box off-gas comprising CH₄, H₂ and CO,
   a H₂-rich stream, and
   a high-purity CO stream;
c. combining at least a part of the purified CO₂ stream from the CO₂ removal unit with at least a part of the cold box off-gas to provide a combined carbon-rich stream;
d. compressing said combined carbon-rich stream;
e. recycling said compressed, combined carbon-rich stream to the reforming section; and
f. reforming said compressed, combined carbon-rich stream in the reforming section.

Additionally, a synthesis gas plant is provided, which comprises:
a reforming section; configured for reforming a process gas in at least one reforming step to a reformed stream comprising CH₄, CO, CO₂, H₂ and H₂O;
a cooling section arranged to cool the reformed stream and condense the water from said reformed stream to produce a dry reformed stream comprising CH₄, CO, CO₂ and H₂;
a CO₂ removal unit arranged downstream said reforming section to receive said reformed stream and separate it into at least a purified CO₂ stream and a CO₂-scrubbed stream having a lower CO₂ content than said purified CO₂ stream;
a cold box arranged downstream said CO₂ removal unit to receive said CO₂-scrubbed stream from said CO₂ removal unit and separate it into at least:
   a cold box off-gas comprising CH₄, H₂ and CO,
   a first high-purity H₂ stream, and
   a high-purity CO stream;
a mixing unit arranged to receive at least a portion of the purified CO₂ stream from the CO₂ removal unit and at least a portion of the cold box off-gas and to mix them together to provide a combined carbon-rich stream;
a compressor arranged to compress said combined carbon-rich stream;
a recycle loop arranged to feed said compressed, combined carbon-rich stream to the reforming section.

### LEGENDS TO THE FIGURES

FIG. 1 shows a schematic of one embodiment of a synthesis gas plant

FIG. 2 shows a schematic of one embodiment of a synthesis gas plant, including a PSA unit

FIG. 3 shows a schematic of another embodiment of a synthesis gas plant, similar to that of FIG. 2, in which the H₂-rich stream from the cold box is recycled and used as fuel for heating the reforming section.

### DETAILED DISCLOSURE

The current technology describes how the carbon balance of a synthesis gas can be improved by utilizing carbon in off-gas from separation processes. Throughout the following, when the content of a certain component in a gas stream is given as a percentage, this should be understood as meaning “mole %” if nothing else is specified.

Specifically, the concept involves recycling carbon containing gasses from the cold box separation process typically included in synthesis gas plants producing CO. The technology relates to combining compression of CO₂ and off-gas in one compressor to save expensive, energy-consuming equipment.

Therefore, a method is provided for increasing the carbon utilisation of a synthesis gas plant. This method comprises six main steps carried out in the described order, and additional steps may be included as desired before, after or in between said steps.

The synthesis gas plant comprises a reforming section in which process gas is reformed in at least one reforming step to a reformed stream comprising a mixture of CH₄, CO, CO₂, H₂ and H₂O. The process gas is typically natural gas. Steam reforming can e.g. be done by, a combination of a tubular reformer (also called steam methane reformer, SMR) and autothermal reforming (ATR), also known as primary and secondary reforming or 2-step reforming. Alternatively, stand-alone SMR or stand-alone ATR can be used to prepare the synthesis gas. Alternatively, convective reformers can be used where a hot gas (as a flue gas or already converted synthesis gas) is used as heating gas to facilitate the reforming reaction. Alternatively, catalytic partial oxidation can be used. Details of these methods are described in “Concepts in Syngas Manufacture” by J. Rostrup-Nielsen and L. J. Christiansen, Imperial College Press; Distributed by World Scientific, 2011.

Additional components upstream the primary reformer may include various pre-reformers and desulphurisation units, through which the natural gas is passed prior to the primary reforming step. These standard components are not illustrated in the enclosed Figures.

Typically, the reforming section is connected directly to a cooling section, where the hot reformed gas is cooled and the remaining water in the gas is condensed and separated. A dry reformed stream is thus provided, which comprises CH₄, CO, CO₂ and H₂.

In a first main step of the method, the dry reformed stream is passed to a CO₂ removal unit to separate it into at least:
a purified CO₂ stream and
a CO₂-scrubbed stream.

By CO₂ removal unit is meant a unit utilizing a process, such as chemical absorption, for removing CO₂ from the process gas. In chemical absorption, the CO₂ containing gas is passed over a solvent which reacts with CO₂ and in this way binds it. The majority of the chemical solvents are amines, classified as primary amines as monoethanolamine (MEA) and digylcolamine (DGA), secondary amines as diethanolamine (DEA) and diiso-propanolamine (DIPA), or tertiary amines as triethanolamine (TEA) and methyldiethanolamine (MDEA), but also ammonia and liquid alkali carbonates as K₂CO₃ and Na₂CO₃ can be used.

The CO₂-scrubbed stream has a lower CO₂ content than the purified CO₂ stream produced in this step, and comprises H₂, CO and CH₄ as primary components. Typically, the CO₂ in the CO₂ scrubbed stream will be less than 1%, and even down to few ppms, while the CO₂ in the CO₂ purified stream typically will be >90%, even >99%.

The purified CO₂ stream exiting the CO₂ removal unit typically has a pressure of around 0.5 barg.

In a second main step of the method, the CO₂-scrubbed stream is passed from the CO₂ removal unit to a cold box. In the cold box, this stream is separated into at least:
a cold box off-gas comprising CH₄, H₂ and CO,
a first high-purity H₂ stream, and
a high-purity CO stream.

The cold box uses cryogenic separation where the phase change of different species in the gas is used to separate individual components from a gas mixture by controlling the temperature. Examples of cold boxes for CO purification includes partial condensation and methane wash, as described in “Carbon Monoxide” by R. Pierantozzi in Kirk-Othmer Encyclopedia of Chemical Technology.

Suitably, the cold box comprises a thermal swing adsorber (TSA) unit, which is used to collect any remaining CO₂ and H₂O in the gas, thus providing a TSA off-gas. The TSA unit is that component of the cold box through which the CO₂-scrubbed stream first passes. In this manner, any traces of CO₂ and water are removed first; otherwise they may condense or freeze in the downstream sections of the cold box. Typically, a small amount (<1%) of the process gas to the TSA will be lost together with the CO₂ and water trapped in the adsorbtion unit. The TSA bed can be regenerated by heating with or without a relevant purge stream. The purge stream can as an example be the H₂-rich gas from the cold box, in which case the small amounts of water and CO₂ in the feed to the TSA will end up in the H₂-rich gas.

In one aspect, at least a portion of the TSA off-gas is provided as a fuel for heating the reforming section, optionally in combination with one or more other off-gases.

In another aspect, at least a portion of the cold box off-gas is provided as a fuel for heating the reforming section, optionally in combination with one or more other off-gases.

The H₂-rich stream is one of the desired products of the synthesis gas plant, and typically has a H₂ content of 97% or greater. Depending on the requirements, this H₂-rich stream may be used “as is”, but it may also be purified further to achieve higher H₂ content, e.g. 99% or greater.

Additional purification of the H₂-rich stream is typically carried out using pressure swing adsorption. Accordingly, the H₂-rich stream from said cold box may be passed to a pressure swing adsorption (PSA) unit to separate it into at least:
a high-purity H₂ stream, and
a PSA off-gas.

The high-purity H₂ stream has a H₂ content which is higher than that of the H₂-rich stream, and is typically 99.9%.

The PSA off-gas from the PSA unit typically comprises H₂, CO, CH₄ and N₂. In one aspect, at least a portion of this PSA off-gas is provided as a fuel for heating the reforming section. The composition of the PSA off-gas will depend on the desired purity of the high-purity H₂ stream for the PSA and generally more H₂ is lost to the PSA off-gas at high purity of the high-purity H₂ stream.

Suitably, a portion of the TSA off-gas, a portion of the PSA off-gas, or a portion of the cold-box off-gas; or a combination thereof is provided as a fuel for heating the reforming section. Most suitably, a combination of a portion of the TSA off-gas and a portion of the PSA off-gas is provided as a fuel for heating the reforming section. Additionally, import of fuel in the form of natural gas to the reforming section can be done to balance the fuel requirement. In some configuration, as for an ATR based reforming section, the fuel will be burned in a fired heater to provide process gas preheating.

The high-purity CO stream from the cold box is one of the desired products of the synthesis gas plant, and typically has a CO content of 98% or greater.

In a third main step of the method, at least a part of the purified CO₂ stream from the CO₂ removal unit is combined with at least a part of the cold box off-gas to provide a combined carbon-rich stream. In one aspect, the entirety of the purified CO₂ stream from the CO₂ removal unit is combined with at least a part of the cold box off-gas. In another aspect, the entirety of the purified CO₂ stream from the CO₂ removal unit is combined with the entirety of the cold box off-gas.

The cold box off-gas and the purified CO₂ stream from the CO₂ removal unit are typically both low pressure gas streams and will contain a relative large portion of the carbon from the natural gas feedstock. To utilize this carbon content, they can be recycled to the reforming section. Additionally, these streams are typically at a similar pressure. This also makes them relatively easy to handle, and easy to mix in the required proportions.

In a fourth main step of the method, the combined carbon-rich stream is compressed, e.g. to a pressure higher than the pressure in the reforming section, such as a pressure of 5 bar, or advantageously 2 bar, above the pressure in the reforming section. As the cold box off-gas and the purified CO₂ stream both are provided at relatively low pressures, it is an advantage to compress said combined carbon-rich stream rather than compressing the individual streams. The compression of said combined carbon-rich stream suitably takes place in a single, multi-stage compressor. This compressor is an expensive and energy-demanding component of a synthesis gas plant, and it is therefore advantageous to use a single compressor for the combined carbon-rich stream rather than having separate compressors for the cold box off-gas and the purified CO₂ stream.

In the fifth and sixth main steps of the method, the compressed, combined carbon-rich stream is recycled to the reforming section and reformed in said reforming section.

The current technology therefore involves taking at least a part of the off-gas from the cold box (which is rich in methane and potentially also CO), and mixing this with at least part of the purified CO₂ stream from the CO₂ removal unit, and compressing this combined stream. This maintains more carbon in the process and increases the carbon economy, consequently reducing the consumption of feed in the reformer. Combining the CO₂ stream and the cold box off-gas before compression, allows for a single (multi-stage) compressor, which means that the extra recycling comes with little extra capital investment, reduced waste and reduced energy consumption. Additionally, recycling of the cold-box off-gas is somewhat counter-intuitive as this gas stream comprises a certain amount of H₂ (typically >20%), and the apparent H₂/CO ratio out of the reforming section will therefore increase, despite an attempt to produce synthesis gas with a low H₂/CO ratio.

In the general method, the compressed, combined carbon-rich stream is recycled to the reforming section and reformed in said reforming section. This may take place independently of the process gas fed to reforming section. However, in a preferred aspect, the compressed, combined carbon-rich stream is mixed with process gas prior to being reformed in the reforming section. In this manner, only one gas feed needs to be supplied to the reforming section.

In one aspect, at least a portion of the H₂-rich stream from said cold box is used as fuel for heating the reforming section. This reduces the import of make-up hydrocarbon fuel to balance the fuel requirement in the reforming section and reduces the CO₂ emission to the environment. In another aspect, the entirety of the purified CO₂ stream from the CO₂ removal unit and the entirety of the cold box off-gas are combined, compressed and recycled to the reforming section and the H₂ rich gas from cold box is used as the only fuel for heating up the reforming section. The balance H₂ rich gas from cold box is used as the product “as is” or may further be purified in the PSA unit. In this aspect, no additional make-up fuel or minimal carbon containing off gases are required as fuel in the reforming section and therefore, the CO₂ emission to the environment is minimized significantly.

In another aspect, a synthesis gas plant is provided, which is suitable for performing the above method. All details of the various units comprising this synthesis gas plant are as described above for the method of the invention.

The synthesis gas plant comprises a reforming section, e.g. a steam reforming section, with functionality as described above. The reforming section is configured for reforming a process gas in at least one reforming step to a reformed gas stream comprising CH₄, CO, CO₂, H₂ and H₂O.

A cooling section is arranged directly downstream the reforming section to cool the reformed stream and condense and separate the principal part of the water. A dry reformed stream is thus produced, comprising CH₄, CO, CO₂ and H₂. The cooling section will typically comprise a combination of waste-heat boilers and heat exchangers for temperature control and flash separation vessels for water removal.

A CO₂ removal unit is arranged downstream said cooling section. The CO₂ removal unit has the components and functionality as described above. It receives the dry reformed stream from the cooling section and separates it into at least a purified CO₂ stream and a CO₂-scrubbed stream having a lower CO₂ content than said purified CO₂ stream.

A cold box is arranged downstream said CO₂ removal unit. The structure and function of the cold box is as described above. It receives the CO₂-scrubbed stream from the CO₂ removal unit and separate it into at least:
a cold box off-gas comprising CH₄, H₂ and CO,
a H₂-rich stream, and
a high-purity CO stream.

The cold box may comprise a thermal swing absorber (TSA) unit, which TSA unit produces the TSA off-gas comprising CO₂ and H₂O.

In those instances, where a higher purity H₂ stream is required, a pressure swing adsorption (PSA) unit is additionally arranged to receive the H₂-rich stream from the cold box and separate it into at least:
a high-purity H₂ stream, and
a PSA off-gas.

The synthesis gas plant further comprises a mixing unit arranged to receive at least a portion of the purified CO₂ stream from the CO₂ removal unit and at least a portion of the cold box off-gas and combine them to provide a combined carbon-rich stream. The mixing unit therefore comprises at least two inlets (one for the purified CO₂ stream from the CO₂ removal unit and one for the cold box off-gas) and one outlet (for the combined carbon-rich stream). The mixing unit may comprise a simple connection between two pipes; one containing the purified CO₂ stream from the CO₂ removal unit and one containing at least a portion of the cold box off-gas. The mixing unit may comprise additional elements such as e.g. valves for regulating one or more gas streams, and may comprise one or more structural elements (e.g. baffles) which promote mixing of the gas streams.

A compressor is arranged downstream the first mixing unit to compress said combined carbon-rich stream. This compressor is suitably a multi-stage compressor.

A recycle loop is arranged to feed said compressed, combined carbon-rich stream to the reforming section. The recycle loop typically comprises gas connections (i.e. tubing) from the outlet of the first mixing unit to the reforming section.

If it is desired to mix the compressed, combined carbon-rich stream with process gas prior to reforming this combined stream, the synthesis gas plant may further comprise a second mixing unit arranged to mix the compressed, combined carbon-rich stream with process gas and to feed the resulting mixed streams to the reforming section.

The plant of the current invention has been described with reference to a number of separate units. Although not described in detail, the plant also comprises gas connections (e.g. tubing, valves) which allow the particular gas flows and connections described above to take place.

As for the method described above, taking the off-gas from the cold box (which is rich in methane and potentially also CO), and mixing this (at least partially) with the purified CO₂ stream from the CO₂ removal unit, and compressing this combined stream maintains more carbon in the process and increases the carbon economy, consequently reducing the consumption of feed in the reformer.

Also, an H₂-rich stream recycle loop may be arranged to feed at least a portion of the H₂-rich stream from the cold box to the reforming section as fuel. In this manner, overall fuel consumption can be reduced, leading to a reduction in overall CO₂ production of the plant, and the possibility of zero make-up hydrocarbon fuel in the plant.

### SPECIFIC EMBODIMENTS

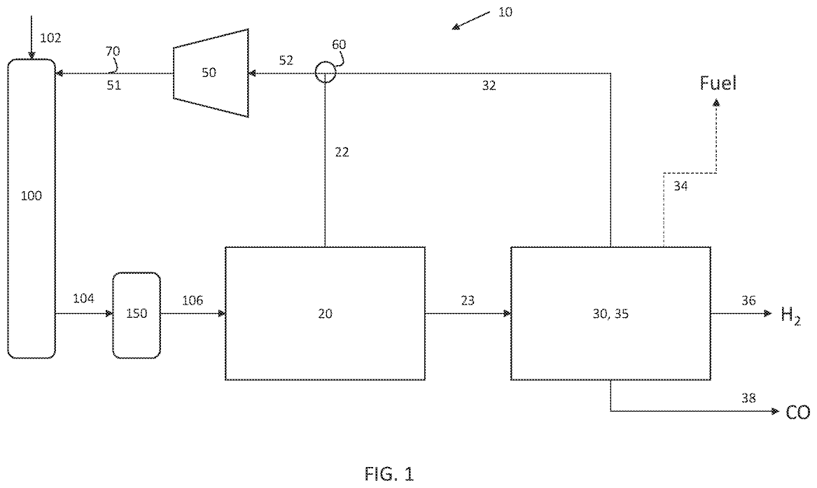

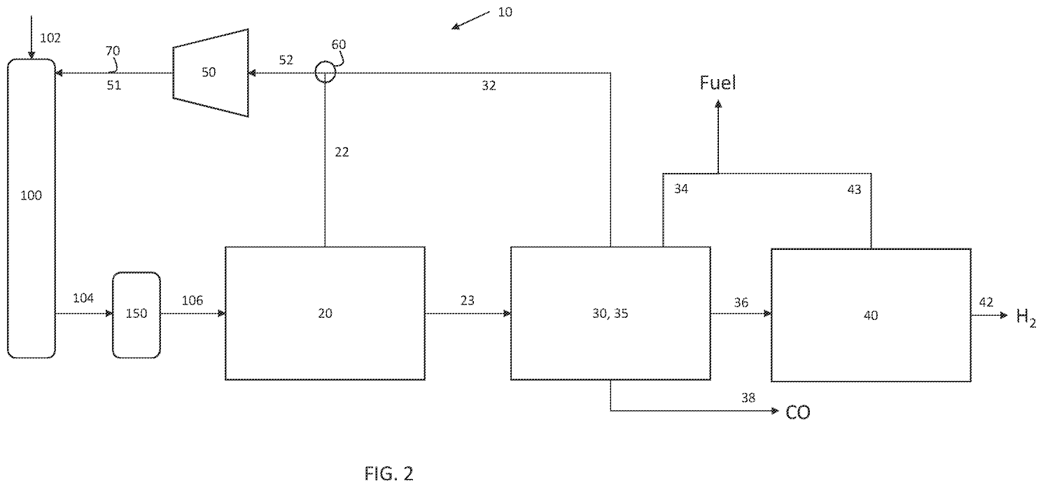

The conceptual process is illustrated in FIGS. 1 and 2.

FIG. 1 shows a schematic of one embodiment of a synthesis gas plant 10. Process gas 102 is fed into a reforming section 100, to provide a reformed gas stream 104. The reformed gas stream 104 is cooled and water is condensed and separated in the cooling section 150 to provide a dry reformed gas 106 comprising CH₄, CO, CO₂ and H₂. This dry reformed gas 106 is passed to a CO₂ removal unit 20 which separates it into at least two gas streams; a purified CO₂ stream 22 and a CO₂ scrubbed stream 23.

The CO₂ scrubbed stream 23 is then passed from the CO₂ removal unit 20 to a cold box 30. Here, it is separated into at least:
a cold box off-gas 32 comprising CH₄, H₂ and CO,
a H₂-rich stream 36, and
a high-purity CO stream 38.

At least a part of the purified CO₂ stream 22 from the CO₂ removal unit 20 is combined with at least a part of the cold box off-gas 32 in the first mixing unit 60 to provide a combined carbon-rich stream 52. This combined carbon-rich stream 52 is compressed in compressor 50, and the compressed, combined carbon rich stream 51 is recycled by the recycle loop 70 to the reforming section 100 where it is reformed. In the illustrated embodiment, the TSA off-gas 34 is used as fuel elsewhere in the plant, typically for heating the reforming section 100.

In the illustrated embodiment, the cold box 30 comprises a thermal swing adsorber (TSA) unit 35, which TSA unit 35 produces a TSA off-gas 34 comprising CO₂ and H₂O.

FIG. 2 shows a schematic of one an embodiment of a synthesis gas plant, which includes a PSA unit. It comprises all elements shown in FIG. 1, plus additional elements. The H₂-rich stream 36 from the cold box 30 is passed to a pressure swing adsorption (PSA) unit 40 to separate it into at least:
a high-purity H₂ stream 42, and
a PSA off-gas 43.

In the illustrated embodiment of FIG. 2, the PSA off-gas 43 is combined with the TSA off-gas 34 from the cold box, and used as fuel elsewhere in the plant, typically for heating the reforming section 100.

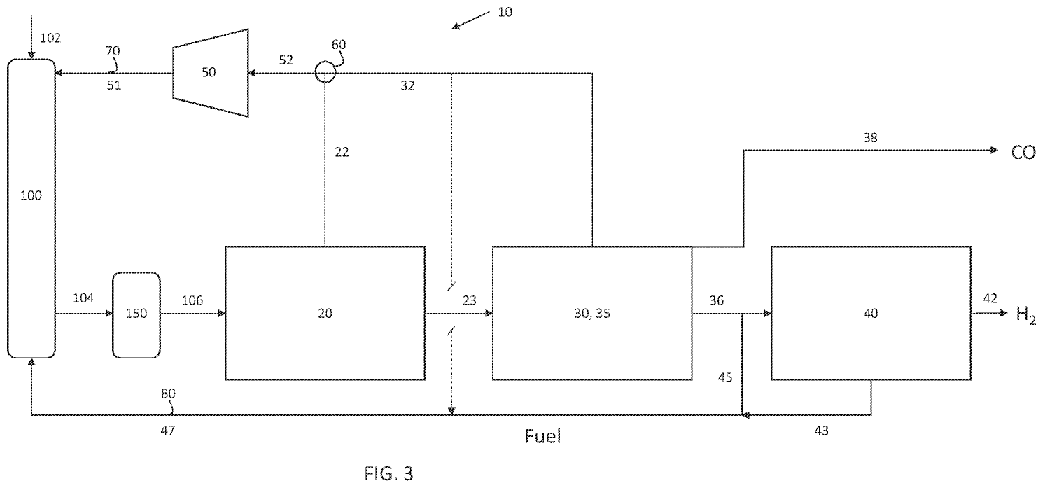

FIG. 3 shows a schematic of one an embodiment of a synthesis gas plant, which includes a H₂-rich stream recycle loop 80. FIG. 3 comprises all elements shown in FIGS. 1 and 2, plus additional elements. As shown, the H₂-rich stream recycle loop 80 is arranged to feed at least a portion of the H₂-rich stream 36 from the cold box 30 to the reforming section 100 as fuel 45 along with the PSA off-gas fuel 43. The combined fuel stream is 47.

The present technology has been described with respect to a number of embodiments and Figures. The person skilled in the art may combine elements from these embodiments and figures as required, within the scope of the invention as defined in the appended claims. All documents referred to herein are incorporated by reference.

### Example 1

Steam Methane Reforming (SMR) with a lean natural gas (NG) feed with CO₂ removal unit, cold box unit and recycle loops as per FIG. 1 was simulated, but without a separate TSA off-gas, so that the TSA off-gas in the simulation ends in the H₂ rich stream in the cold box. Minor components such as prereformer, desulfurisation unit, cooling section as well as some minor process streams such as compressor loss streams are not highlighted in the table presented below. However, these minor components are indeed part of the simulation.

Software simulations were made of the NG feed required to provide a certain CO product flow, at various partial recycles of off-gas from the cold box.

Calculations of energy and mass balance of the chemical process were performed and the results are summarised as shown in the table below:

| | Stream | | | | |
|---|---|---|---|---|---|
| | numbers | | | | |
| | as in FIG. 1 | | | | |
| | (wherever | | | | |
| Parameters | applicable) | Units | Values | | |
| Fraction of off-gas recycle | | 1/1 | 0 | 0.25 | 0.5 |
| NG feed flow | | Nm³/h | 21114 | 20206.3 | 19142.3 |
| NG feed composition | | | | | |
| CH₄ | | mol % | 97.71 | 97.71 | 97.71 |
| C2+ | | mol % | 0.88 | 0.88 | 0.88 |
| CO₂ | | mol % | 0.70 | 0.70 | 0.70 |
| N₂ | | mol % | 0.71 | 0.71 | 0.71 |
| S/C ratio | | mol/mol | 1.5 | 1.5 | 1.5 |
| Steam flow | | kg/h | 25418 | 24325 | 23043 |
| Process gas feed to reforming | 102 | Nm³/h | 55230.3 | 52855.5 | 50076.4 |
| section 100 (wet flow) | | | | | |
| Feed process gas composition | | | | | |
| H₂ | | mol % | 7.70 | 7.70 | 7.70 |
| CH₄ | | mol % | 36.31 | 36.31 | 36.31 |
| CO | | mol % | 0.04 | 0.04 | 0.04 |
| CO₂ | | mol % | 2.09 | 2.09 | 2.09 |
| N₂ | | mol % | 0.27 | 0.27 | 0.27 |
| H₂O | | mol % | 53.58 | 53.58 | 53.58 |
| Reformed gas from reforming | 104 | Nm³/h | 88538.1 | 87391.7 | 86174.8 |
| section 100 (wet flow) | | | | | |
| Reformed gas composition | | | | | |
| H₂ | | mol % | 53.21 | 53.71 | 54.28 |
| CH₄ | | mol % | 6.1 | 6.79 | 7.77 |
| CO | | mol % | 17.88 | 18.11 | 18.37 |
| CO₂ | | mol % | 4.45 | 4.18 | 3.84 |
| N₂ | | mol % | 0.17 | 0.17 | 0.16 |
| H₂O | | mol % | 18.2 | 17.04 | 15.59 |
| Purified CO₂ from section 20 | 22 | Nm³/h | 3962.7 | 3676 | 3329.6 |
| (dry flow) | | | | | |
| CO₂ purity | | dry mol % | 99.11 | 99.09 | 99.06 |
| Off-gas from Cold box section 30 | | Nm³/h | 6197.4 | 6730.6 | 7487.3 |
| (dry flow) | | | | | |
| Off gas composition | | | | | |
| H₂ | | dry mol % | 15.19 | 13.94 | 12.49 |
| CH₄ | | dry mol % | 75.72 | 77.68 | 79.98 |
| CO | | dry mol % | 8.97 | 8.27 | 7.44 |
| N₂ | | dry mol % | 0.12 | 0.11 | 0.09 |
| Off-gas recycle flow | 32 | Nm³/h | 0 | 1682.7 | 3743.7 |
| Inlet flow at CO₂ recycle | 52 | Nm³/h | 3962.7 | 5358.7 | 7073.3 |
| compressor 50 (dry flow) | | | | | |
| CO product flow from section 30 | 38 | Nm³/h | 15000 | 15000 | 15000 |
| (as 100% CO) | | | | | |
| CO purity of CO product | | dry mol % | 99.06 | 99.09 | 99.12 |
| Balance H₂ product flow from | 36 | Nm³/h | 46139.8 | 45977 | 45814.5 |
| section 30 (as 100% H₂) | | | | | |
| H₂ purity of H₂ product | | dry mol % | 97.99 | 97.99 | 97.99 |

Essentially, the calculations show that for a given level of CO product flow (15000 Nm³/h) the consumption of natural gas falls as the recycle fraction of the cold box off-gas in the recycled gas increases.

In the table above, “S/C” is meant to denote the steam-to-carbon-ratio, which is the ratio of the amount of steam to carbon in the hydrocarbons in the process gas.

### Example 2

Steam Methane Reforming (SMR) with a lean natural gas (NG) feed with CO₂ removal unit, cold box unit, PSA unit and recycle loops as per FIG. 3 was simulated. A portion of H₂ rich stream from the cold box is mixed with the PSA off-gas and provided as the fuel to the reforming section. Minor components such as prereformer, desulfurisation unit, cooling section as well as some minor process streams such as compressor loss streams are not highlighted in the table presented below. However, these minor components are indeed part of the simulation.

Software simulations were made of the NG feed required to provide a certain CO product flow. Two simulations are listed in the below table; first, in which all the cold box off-gas and PSA off-gas is provided as the fuel along with a balance make-up hydrocarbon fuel to the reforming section and all the H₂ rich stream is processed in the PSA unit to be purified into a high purity H₂ product stream; second, in which the combined stream of all the cold box off-gas and purified CO₂ stream from CO₂ removal unit is recycled to the reforming section as feed and a portion of H₂ rich stream from cold box along with PSA off-gas is provided as the fuel to the reforming section without the requirement of any make-up fuel.

Calculations of energy and mass balance of the chemical process were performed and the results are summarised as shown in the table below:

| | Stream | | | |
|---|---|---|---|---|
| | numbers | | | |
| | as in | | | |
| | FIG. 3 | | | |
| | (wherever | | | |
| Parameters | applicable) | Units | Values | |
| Fraction of Off-gas recycle | | 1/1 | 0 | 1 |
| NG feed flow | | Nm³/h | 21131.9 | 15899.7 |
| NG feed composition | | | | |
| CH₄ | | mol % | 97.71 | 97.71 |
| C2+ | | mol % | 0.88 | 0.88 |
| CO₂ | | mol % | 0.70 | 0.70 |
| N₂ | | mol % | 0.71 | 0.71 |
| S/C ratio | | mol/mol | 1.5 | 1.5 |
| Steam flow | | kg/h | 25432 | 19131 |
| Process gas feed to reforming | 102 | Nm³/h | 59239.2 | 55164.1 |
| section 100 (wet flow) | | | | |
| Feed process gas composition | | | | |
| H₂ | | mol % | 7.23 | 7.52 |
| CH₄ | | mol % | 33.88 | 45.17 |
| CO | | mol % | 0.05 | 1.05 |
| CO₂ | | mol % | 8.56 | 5.52 |
| N₂ | | mol % | 0.25 | 0.22 |
| H₂O | | mol % | 50.02 | 40.53 |
| Reformed gas from reforming | 104 | Nm³/h | 88563.1 | 83943.7 |
| section 100 (wet flow) | | | | |
| Reformed gas composition | | | | |
| H₂ | | mol % | 53.22 | 55.35 |
| CH₄ | | mol % | 6.11 | 12.54 |
| CO | | mol % | 17.87 | 18.85 |
| CO₂ | | mol % | 4.44 | 2.6 |
| N₂ | | mol % | 0.17 | 0.14 |
| H₂O | | mol % | 18.19 | 10.51 |
| Purified CO₂ from section 20 | 22 | Nm³/h | 3961.4 | 2204.6 |
| (dry flow) | | | | |
| CO₂ purity | | dry mol % | 99.11 | 98.9 |
| Off-gas from Cold box | | Nm³/h | 6202.2 | 11317.3 |
| section 30 (dry flow) | | | | |
| Off-gas composition | | | | |
| H₂ | | dry mol % | 15.19 | 8.21 |
| CH₄ | | dry mol % | 75.73 | 86.8 |
| CO | | dry mol % | 8.96 | 4.94 |
| N₂ | | dry mol % | 0.12 | 0.05 |
| Cold box off-gas recycle dry | 32 | Nm³/h | 0 | 11317.3 |
| flow | | | | |
| Inlet flow at CO₂ recycle | 52 | Nm³/h | 3961.4 | 13521.8 |
| compressor 50 (dry flow) | | | | |
| CO product flow | 38 | Nm³/h | 15000 | 15000 |
| from section 30 | | | | |
| (as 100% CO) | | | | |
| CO purity of CO product | | dry mol % | 99.06 | 99.25 |
| H₂ rich stream (dry flow) | 36 | Nm³/h | 47107.4 | 46449.9 |
| from cold box section 30 | | | | |
| H₂ rich stream composition | | | | |
| H₂ | | dry mol % | 97.99 | 97.99 |
| CH₄ | | dry mol % | 1.5 | 1.5 |
| CO | | dry mol % | 0.5 | 0.5 |
| CO₂ | | dry mol % | 0.01 | 0.01 |
| H₂ product (dry flow) from | 42 | Nm³/h | 41587.3 | 21056.7 |
| section 40 | | | | |
| H₂ purity of H₂ product | | dry mol % | 99.9 | 99.9 |
| Fuels | | | | |
| H₂ rich stream fuel (dry flow) | 45 | Nm³/h | 0 | 22598 |
| Cold box off-gas fuel (dry | | Nm³/h | 6202.2 | 0 |
| flow) | | | | |
| Combined fuel (dry flow) | 47 | Nm³/h | 11722.3 | 25393.2 |
| Combined fuel composition | | | | |
| H₂ | | dry mol % | 47.42 | 96.41 |
| CH₄ | | dry mol % | 45.74 | 2.66 |
| CO | | dry mol % | 6.75 | 0.91 |
| CO₂ | | dry mol % | 0.03 | 0.02 |
| N₂ | | dry mol % | 0.06 | 0 |
| Make-up fuel flow | | Nm³/h | 878.9 | 0 |
| Make-up fuel LHV | | kcal/Nm³ | 13322.5 | 13322.5 |
| Flue gas stream CO₂ flow | | Nm³/h | 7700 | 933 |

1. A method for increasing the carbon utilization of a synthesis gas plant, said synthesis gas plant comprising a reforming section in which process gas is first reformed in at least one reforming step to a reformed gas stream; and a cooling section in which the reformed gas stream is cooled to provide a dry reformed stream comprising CH₄, CO, CO₂ and H₂, said method comprising the steps of:
a. passing the dry reformed stream to a CO₂ removal unit to separate it into at least:
a purified CO₂ stream and
a CO₂-scrubbed stream having a lower CO₂ content than said purified CO₂ stream;
b. passing the CO₂-scrubbed stream from the CO₂ removal unit to a cold box to separate it into at least:
a cold box off-gas comprising CH₄, H₂ and CO,
a H₂-rich stream, and
a high-purity CO stream;
c. combining at least a part of the purified CO₂ stream from the CO₂ removal unit with at least a part of the cold box off-gas to provide a combined carbon-rich stream;
d. compressing said combined carbon-rich stream;
e. recycling said compressed, combined carbon-rich stream to the reforming section; and
f. reforming said compressed, combined carbon-rich stream in the reforming section.

2. The method according to claim 1, wherein said H₂-rich stream from said cold box is passed to a pressure swing adsorption (PSA) unit to separate it into at least:
a high-purity H₂ stream, and
a PSA off-gas.

3. The method according to claim 1, wherein the cold box comprises a thermal swing adsorber (TSA) unit, which TSA unit produces a TSA off-gas comprising CO₂ and H₂O.

4. The method according to claim 3, wherein a portion of the TSA off-gas, a portion of the PSA off-gas, or a portion of the cold-box off-gas; or a combination thereof is provided as a fuel for heating the reforming section.

5. The method according to claim 1, wherein the reformer section comprises an autothermal reformer (ATR), a steam methane reformer (SMR), a convective reformer or a catalytic partial oxidation (CATOX) unit.

6. The method according to claim 1, wherein the compressed, combined carbon-rich stream is mixed with process gas prior to being reformed in the reforming section.

7. The method according to claim 1, wherein the entirety of the purified CO₂ stream from the CO₂ removal unit is combined with the entirety of the cold box off-gas to provide said combined carbon-rich stream.

8. The method according to claim 1, wherein at least a portion of the H₂-rich stream from said cold box is used as fuel for heating the reforming section.

9. A synthesis gas plant, comprising:
a reforming section; configured for reforming a process gas in at least one reforming step to a reformed stream comprising CH₄, CO, CO₂, H₂ and H₂O;
a cooling section arranged to cool the reformed stream and condense the water from said reformed stream to produce a dry reformed stream comprising CH₄, CO, CO₂ and H₂;
a CO₂ removal unit arranged downstream said reforming section to receive said reformed stream and separate it into at least a purified CO₂ stream and a CO₂-scrubbed stream having a lower CO₂ content than said purified CO₂ stream;
a cold box arranged downstream said CO₂ removal unit to receive said CO₂-scrubbed stream from said CO₂ removal unit and separate it into at least:
a cold box off-gas comprising CH₄, H₂ and CO,
a H₂-rich stream, and
a high-purity CO stream;
a first mixing unit arranged to receive at least a portion of the purified CO₂ stream from the CO₂ removal unit and at least a portion of the cold box off-gas and to combine them to provide a combined carbon-rich stream;
a compressor arranged to compress said combined carbon-rich stream; and
a recycle loop arranged to feed said compressed, combined carbon-rich stream to the reforming section.

10. The synthesis gas plant of claim 9, further comprising a pressure swing adsorption (PSA) unit arranged to receive the H₂-rich stream from said cold box and separate it into at least:
a high-purity H₂ stream, and
a PSA off-gas.

11. The synthesis gas plant according to claim 9, wherein the reformer section comprises an autothermal reformer (ATR), a steam methane reformer (SMR), a convective reformer or a catalytic partial oxidation (CATOX) unit, preferably an ATR or SMR unit.

12. The synthesis gas plant according to claim 9, wherein the cold box comprises a thermal swing absorber (TSA) unit, which TSA unit produces a TSA off-gas comprising CO₂ and H₂O.

13. The synthesis gas plant according to claim 9, further comprising a second mixing unit arranged to mix the compressed, combined carbon-rich stream with process gas and to feed the resulting mixed streams to the reforming section.

14. The synthesis gas plant according to claim 9, further comprising a H2-rich stream recycle loop arranged to feed at least a portion of the H₂-rich stream from the cold box to the reforming section as fuel.
